(19) United States
(12) Patent Application Publication
(10) Pub. No.: US 2018/0364371 A1
(43) Pub. Date: Dec. 20, 2018

(54) Calibration Systems and Methods

(71) Applicant: Battelle Memorial Institute, Richland, WA (US)

(72) Inventors: Todd W. Hossbach, Richland, WA (US); Tracy A. Roberts, Richland, WA (US)

(73) Assignee: Battelle Memorial Institute, Richland, WA (US)

(21) Appl. No.: 15/679,888

(22) Filed: Aug. 17, 2017

Related U.S. Application Data
(60) Provisional application No. 62/377,397, filed on Aug. 19, 2016.

(51) Int. Cl. G01T 1/208; G01T 7/00; G01T 1/20

(52) U.S. Cl. CPC G01T 1/208; G01T 1/2006; G01T 7/005

(57) ABSTRACT

Calibration systems and methods are described. According to one aspect, a calibration system includes a light source configured to emit light, and drive circuitry coupled with the light source, and wherein the drive circuitry is configured to apply a drive signal to the light source to cause the emission of the light from the light source which corresponds to a light emission from a scintillator resulting from exposure of the scintillator to a radioactive source.

### RELATED PATENT DATA

This application claims the benefit of U.S. Provisional Patent Application Ser. No. 62/377,397, filed Aug. 19, 2016, titled “Scintillator Light-Output Simulator”, the disclosure of which is incorporated herein by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### TECHNICAL FIELD

This disclosure relates to calibration systems and associated methods.

### BACKGROUND OF THE DISCLOSURE

Scintillators are currently utilized in many applications including radiation detection, particle detection, new energy resource exploration, X-ray security, nuclear cameras, computed tomography and gas exploration. Scintillators are often used in conjunction with radiation detectors which include photo sensors, such as photomultiplier tubes, for detecting and measuring radioactive contamination and monitoring nuclear material. Radiation detectors may need to be calibrated to provide accurate detection and calibration of radiation detectors is typically accomplished with radioactive calibration sources. In particular, scintillators include a material that exhibits scintillation when excited by ionizing radiation. More specifically, the scintillator material absorbs the energy of an incoming particle and emits the absorbed energy in the form of light. Example materials of a scintillator include sodium iodide and calcium fluoride which emit photons upon absorption of a radioactive emission. The emitted light is provided to a photo sensor which generates electrical signals as a result of the light received from the scintillator. The electrical signals may be processed to identify the radiation received by the scintillator. However, scintillators have downsides that include the use of a radioactive source for calibration and they are relatively expensive.

The simulator systems according to some embodiments described herein were created for the purpose of replicating the light output of scintillators used in radiation detection without the use of radioactive materials. The process by which the scintillator emits light is fluorescence. Fluorescence is the prompt emission of visible radiation (photons) from a substance following its excitation by some means (radiation source). The decay time of most scintillators is very fast, including inorganic materials with decay times of 230 ns-950 ns.

Referring to FIG. 1, a conventional scintillator 11 is shown which receives incoming radiation 10 and outputs photons or light 12 responsive thereto. The photons produced by the scintillator are directed through an optical window 16 towards a photo-sensitive device 14 in the form of a photomultiplier tube (PMT) which includes a photocathode 18 and anode 20 which converts the photon input to current output. The current induces a voltage across a resistor which can be measured and analyzed using a measuring device 22 to determine the spectrum of energies of the pulses. This information can be used to determine what type of radiation the scintillator was exposed to.

Three important characteristics of the light pulse created by a scintillator/source combination are wavelength, pulse decay time and pulse amplitude. The scintillator emits light pulses of a specific wavelength with an exponential decaying amplitude. Both decay time and wavelength are determined by the type of scintillation material. Peak amplitude of the pulse is related to the energy deposited in the scintillator by the radiation source. Higher energy produces a larger amplitude light pulse. When a scintillator is exposed to a source it will produce light pulses with a spectrum of pulse amplitudes characteristic of the source, and with decay time and wavelength characteristics of the scintillator. The spectrum of pulse amplitudes can be analyzed to further determine what type of radiation is present.

Referring to FIG. 2, a spectrum of light pulses produced by a scintillator (Nal(TI)) and source (Co60) and measured using a measuring device is shown. The x-axis represents the energy of the pulse, which is deduced from the peak amplitude of the current pulse emitted by the scintillation detector. The current induces a voltage across a resistor, which is measured by the measuring device, such as a multichannel analyzer (MCA), and converted into a channel. The expected channel of a pulse can be determined by using its observed peak voltage (Vpeak), determined via an oscilloscope.

$$Expected Channel = {V}_{peak} * \frac{\# MCA Channels}{MCA Voltage Range}$$

The voltage range and number of channels is a function of the measuring device and may be selected by the user. The Y axis is the number of counts at each energy level. As the measuring device runs, it counts the number of pulses of each energy level and plots it on the graph. The final spectrum gives a representation of the distribution of various pulse amplitudes present. The inventive calibration systems described below generate the spectrum of light pulses without the use of the scintillator and source.

At least some aspects of the disclosure described below are directed towards apparatus and methods which may be used to calibrate radiation detectors without the use of radiation sources.

### BRIEF DESCRIPTION OF THE DRAWINGS

Example embodiments of the disclosure are described below with reference to the following accompanying drawings.

FIG. 1 is a functional block diagram of a conventional scintillator and source used for calibration.

FIG. 2 is a graphical representation of a spectrum of light pulses generated using a Nal(TI) scintillator and Co60 radioactive source.

FIG. 3 is a functional block diagram of a calibration system according to one example embodiment.

FIG. 4 is a graphical representation of measurements of LED emissions according to one embodiment.

FIGS. 5A and 5B are graphical representations of an emitted pulse and corresponding measurements at a measuring device according to one embodiment.

FIG. 6 is a flow chart of a method of generating a plurality of pulses having different characteristics according to one embodiment.

FIG. 7 is a schematic representation of processing circuitry of drive circuitry according to one embodiment.

FIG. 8 is a map illustrating how FIGS. 8A and 8B are assembled. Once assembled, FIGS. 8A and 8B depict a schematic representation of circuit components of drive circuitry according to one embodiment.

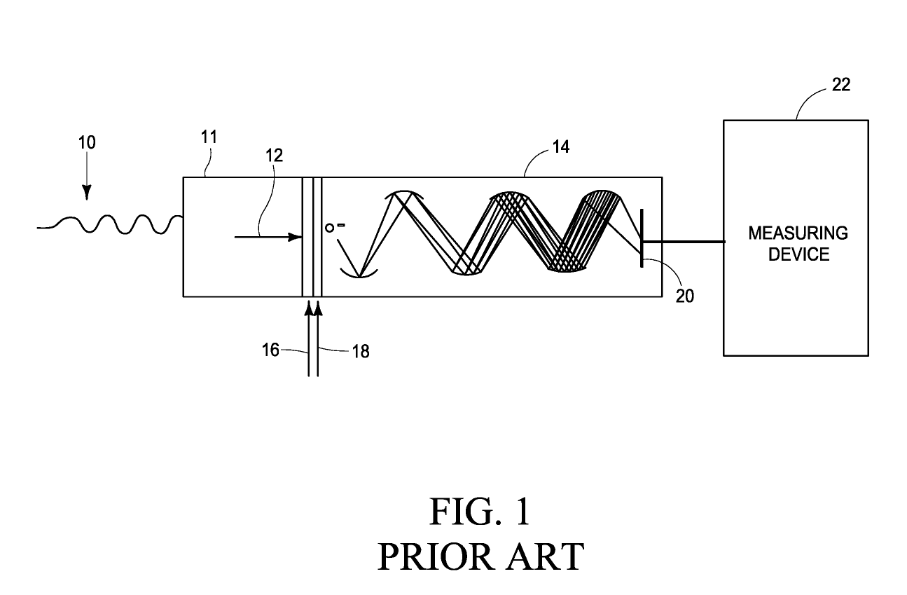

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

Eliminating the need for radioactive sources in the calibration of radiation detectors, especially in field applications, has benefits as mentioned above. Examples embodiments of the disclosure provide calibration systems which utilize light sources, such as one or more LEDs, without the use of a radioactive source material. Some example embodiments of the system described below include two primary components—pulse generation and light output—providing the user with maximum flexibility to define synthetic scintillation pulses as well as the light output characteristics of the calibration system. Details of example embodiments of scintillator light-output simulator systems which may be used for calibration of radiation detectors and associated methods are described below.

Common scintillation materials include Nal(TI) and CaF2(Eu) for routine gamma-ray spectroscopy. Nal(TI) has a 415 nm wavelength, 230 ns decay time, and emits 38 k photons/MeV deposited. CaF2(Eu) has a long decay time of 900 ns and has about 50% of the light yield of Nal(TI) and its dominant wavelength is 435 nm. The characteristics of these two materials represent a range of decay times and wavelength the scintillation simulator should be able to reproduce. In some embodiments described below, characteristics of the drive signal (e.g., amplitude, decay time, frequency of pulses) may be adjusted to replicate numerous scintillators and sources.

Pulse generation is accomplished with a microprocessor-controlled analog circuit in some embodiments disclosed herein. The analog circuit precisely controls the light output of the light source of the calibration system so as to mimic the exponentially decaying light emission from a real scintillator. The RC time constant of the decay is adjusted via a digital variable resistor controlled by the microcontroller in one embodiment. The microprocessor is used to control the rate of light source pulsing as well as the intensities of light emissions from the light source in one embodiment.

In some implementations, the pulse generation circuit is capable of generating an equivalent single-point energy calibration (e.g., light pulses of a single amplitude) or multi-point energy calibration (e.g., plural light pulses of different amplitudes and/or wavelengths or decay times for more than one light source 54), or alternatively, the user can upload a simulated or previously-obtained energy spectrum and allow the device to automatically adjust the light output of the light source so as to create a synthetic energy spectrum, such as a gamma ray spectrum. In this regard, the light output of the light source corresponds to the energy deposited in a scintillator by a radiation source. Accordingly, some embodiments enable the recreation/generation of a complete energy distribution of a radioactive source without use of radioactive material. Calibration systems discussed below may also be used to design and develop photo sensors without the use of scintillators and a radioactive source.

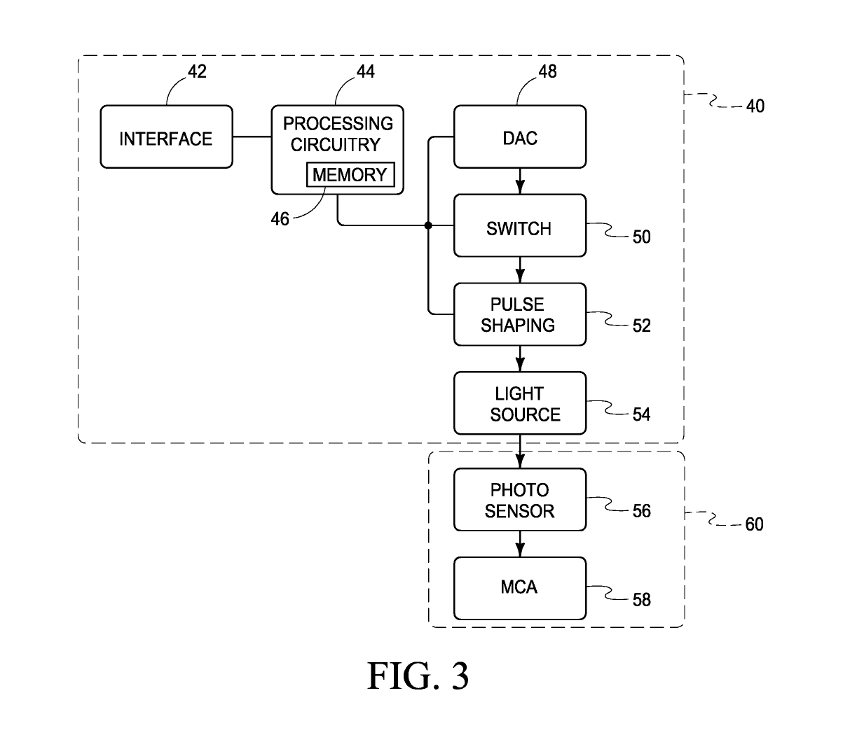

Referring to FIG. 3, an example calibration system 40 is shown according to one embodiment. The illustrated example system 40 includes a user interface 42, processing circuitry 44 with memory 46, digital-to-analog converter (DAC) 48, switch 50, pulse shaping circuit 52 and a light source 54. Processing circuitry 44, DAC 48, switch 50 and pulse shaping circuit 52 may be referred to as drive circuitry configured to generate a drive signal which causes the emission of light from light source 54 in example embodiments discussed below. A plurality of drive circuits may be used to generate a plurality of drive signals for a plurality of different light sources in some embodiments.

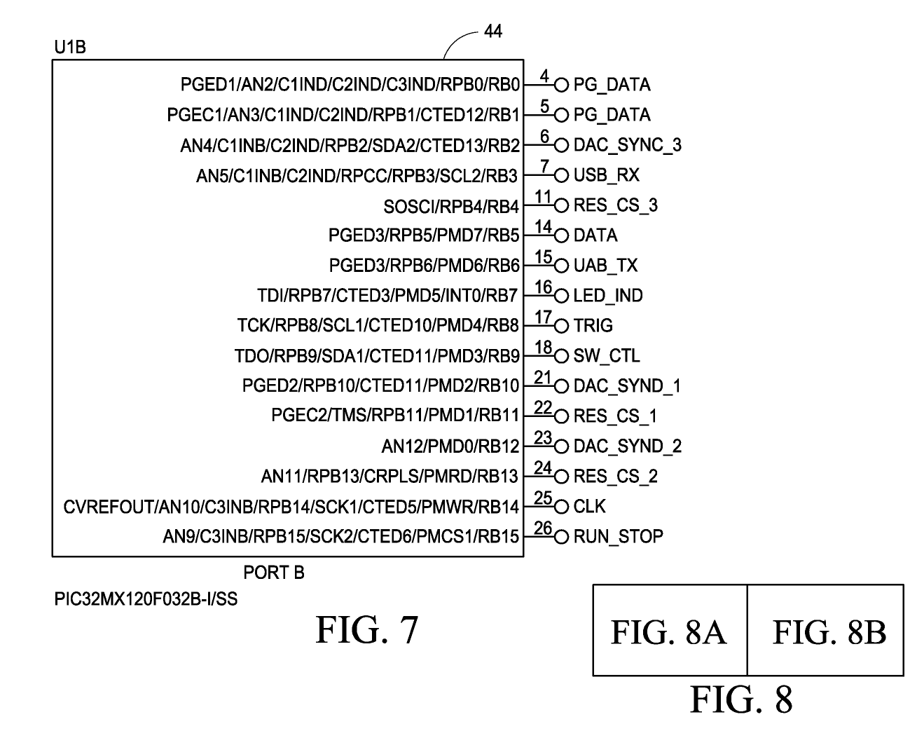

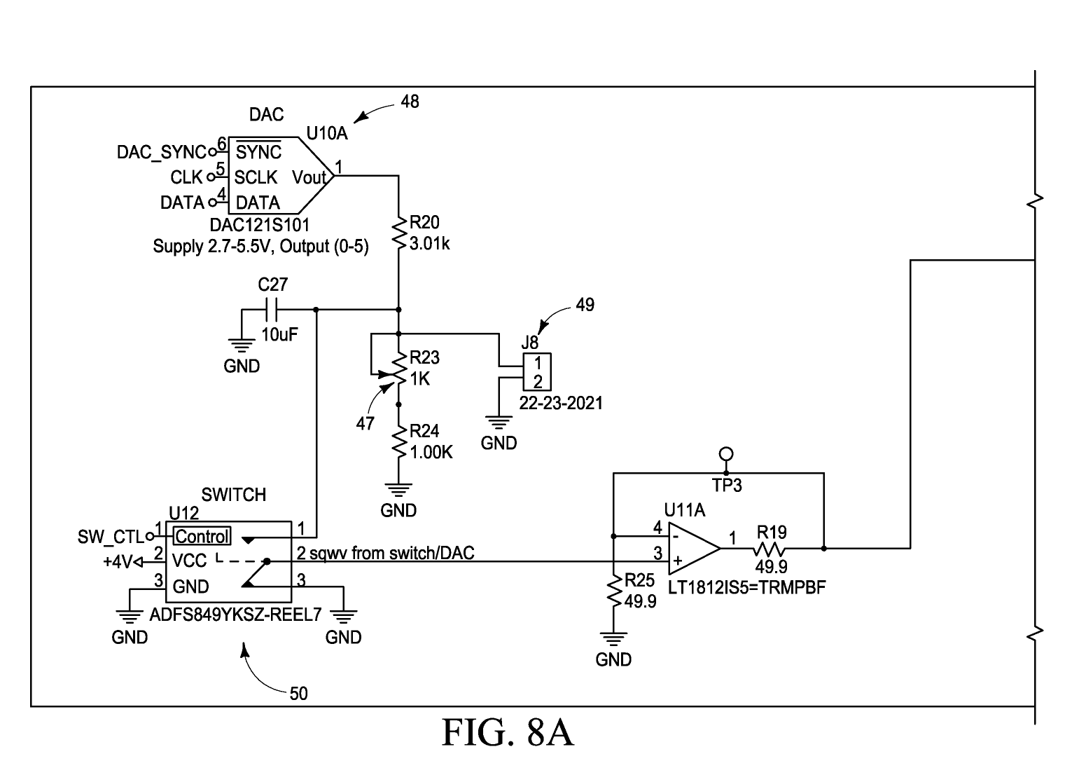

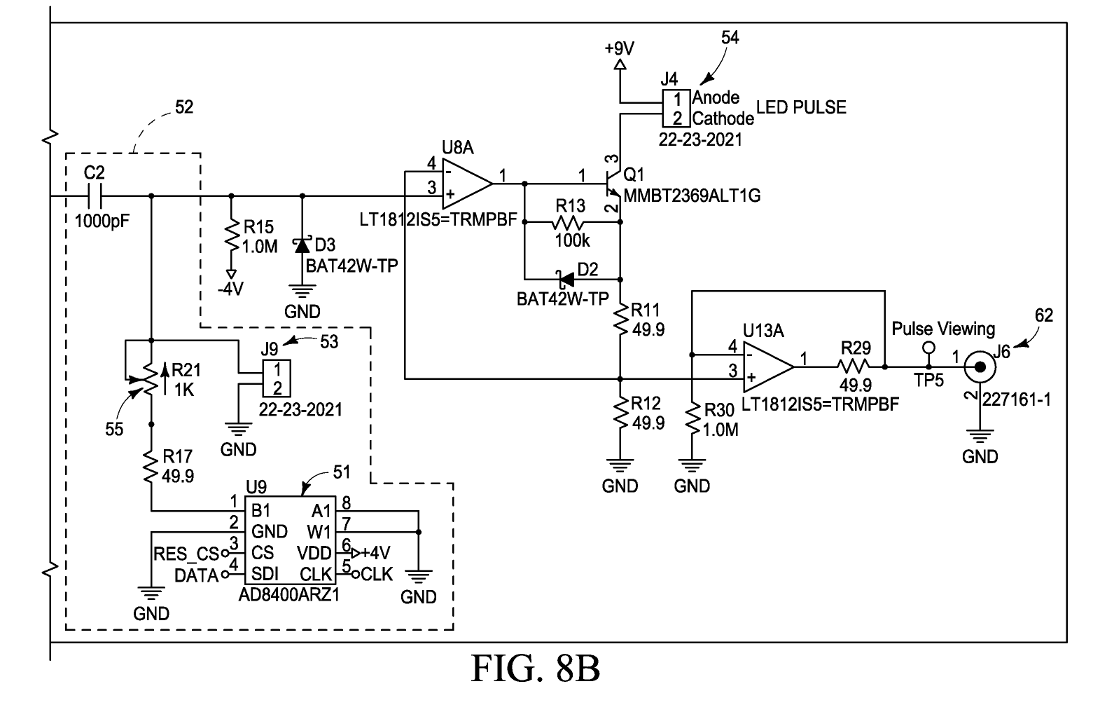

In some embodiments, the drive circuitry generates the drive signal to cause the emission of light from the light source which corresponds to a light emission from a scintillator resulting from exposure of the scintillator to a radioactive source. These light emissions may be used to calibrate one or more radiation detectors in example applications. In example embodiments discussed below, the drive circuitry is configured to generate the drive signal including a plurality of electrical pulses which cause the generation of a plurality of corresponding light pulses. Other embodiments of system 40 are possible including more, less and/or additional components. Additional details regarding one embodiment of drive circuitry are discussed below with respect to FIGS. 7-8.

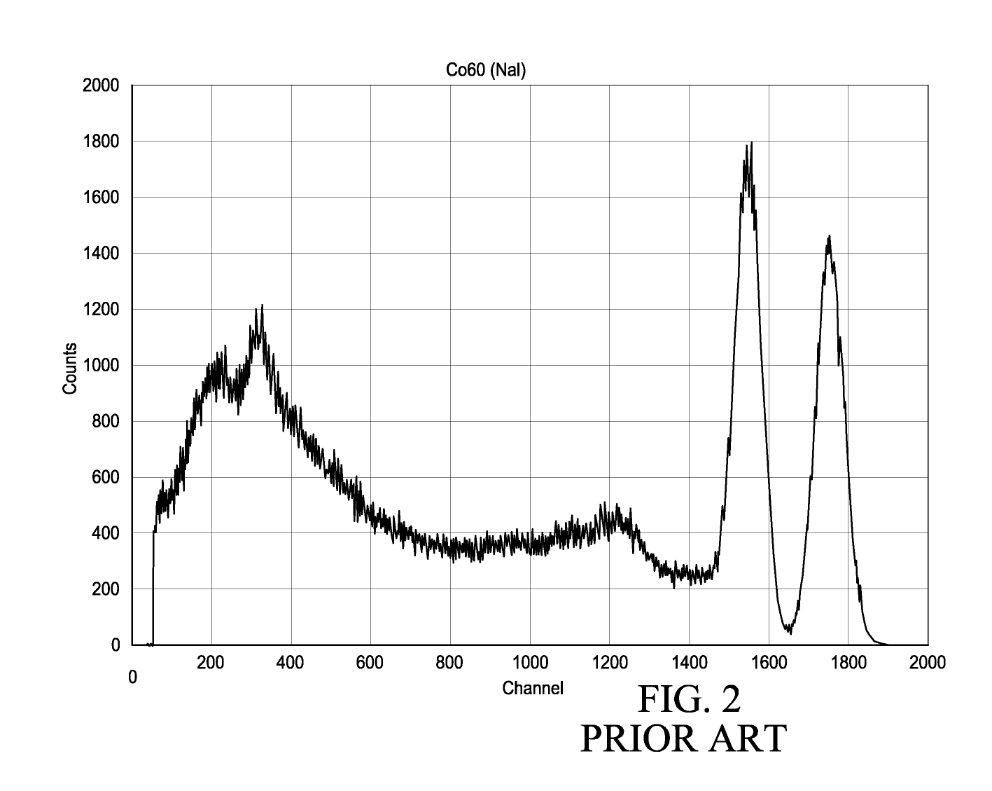

Light generated by the system 40 to replicate emissions from a scintillator is applied to a photo sensor 56 which generates electrical signals corresponding to the received light. A measuring device 58 such as a multi-channel analyzer receives the electrical signals and generates a spectrum, such as shown in FIG. 2, in one embodiment.

User interface 42 receives user inputs and may be implemented in any suitable manner, such as a graphical user interface and/or manual controls accessible to a user. A user may input various information regarding the generation of light pulses by the calibration system 40. For example, the user may initiate calibration operations, control various aspects or characteristics of the emitted light (e.g., frequency, amplitude, decay of pulses). In some embodiments, the user may manually control one or more light characteristics (amplitude/intensity of light pulses and decay time of the light pulses) and or control the downloading of digital data which may be used by the system to generate an entire spectrum of light pulses (synthetic spectrum) to simulate a scintillator exposed to a real radioactive source.

Processing circuitry 44 is configured to access commands and data entered by user interface 42 and to process data, control data access and storage, issue commands, and control other operations implemented by the calibration system 40. In more specific examples, the processing circuitry 44 is configured to access data values which are used to control characteristics of light pulses emitted by calibration system 40. In one specific embodiment described below, processing circuitry 44 controls the intensity of the emitted light pulses via digital-to-analog converter 48, controls the frequency of the pulses via switch 50, and shaping of the pulses (e.g., decay constant or times of decay of the pulses) via pulse shaping circuitry 52.

Processing circuitry 44 may comprise circuitry configured to implement desired programming provided by appropriate computer-readable storage media in at least one embodiment. For example, the processing circuitry 44 may be implemented as one or more processor(s) and/or other structure configured to execute executable instructions including, for example, software and/or firmware instructions. Other exemplary embodiments of processing circuitry 44 include hardware logic, PGA, FPGA, ASIC, and/or other structures alone or in combination with one or more processor(s).

In one embodiment, processing circuitry 44 includes internal memory 46. In other embodiments, other types of storage circuitry including circuitry external of memory 46 may be used to store digital information alone or in addition to memory 46. Memory 46 is configured to store programming such as executable code or instructions (e.g., software and/or firmware), electronic data, databases, or other digital information and may include computer-readable storage media.

At least some embodiments or aspects described herein may be implemented using programming stored within one or more computer-readable storage medium and configured to control processing circuitry 44. In addition, memory 46 may store spectrum data which may be used to control light source 54 to emit light pulses corresponding to an entire spectrum of light emissions from a scintillator being simulated. Memory 46 or other storage circuitry may also be referred to as non-transitory computer-readable storage media and include any one of physical media such as electronic, magnetic, optical, electromagnetic, infrared or semiconductor media, a hard drive, random access memory, read only memory, flash memory, cache memory, and/or other configurations capable of storing programming, data, or other digital information.

In one embodiment, processing circuitry 44 provides control signals to digital-to-analog converter (DAC) 48 which selects the intensity of pulses of light generated and emitted by calibration system 40. Processing circuitry 44 programs DAC 48 which is implemented as a 12-bit DAC in one embodiment to output an electrical signal having a voltage of 0-4V in one embodiment. In one implementation, pulses of a single amplitude may be generated (e.g., for single-point energy calibration) while the amplitude of the pulses may be varied in other implementations (e.g., multi-point energy calibration or use of a spectrum). The control signals from processing circuitry 44 may select different voltage amplitudes of electricity outputted by DAC 48 (e.g., 0-4 V) which is scaled to a range of 0-1V via resistors which form a voltage divider and applied to switch 50 and which results in the generation and emission of light pulses from light source 54 having different intensities. In another embodiment, the voltage output of the DAC 48 is held constant (or electricity having a constant voltage is used) and a turn potentiometer may be used to create an adjustable voltage divider, allowing for analog amplitude adjustment of the electricity used to generate the electrical pulses for generating the light pulses.

Switch 50 is configured to generate a plurality of electrical pulses having voltage amplitudes of the electricity received from DAC 48. The electrical pulses generated by switch 50 are in the form of square waves and are generated at a frequency selected by processing circuitry 44 in one embodiment. The generated electrical pulses are applied to pulse shaping circuit 52. A square wave from the processing circuitry is used to control switch 50 in one embodiment. The frequency of the square wave can be manually adjusted or adjusted via the user interface under control of the processing circuitry in example embodiments. A default frequency range of pulses which may be used is 10-100 Hz in 10 Hz increments in but one illustrative example. The frequency of the generation of the drive signal pulses and corresponding light pulses may correspond to a level of radioactivity to be simulated, including lower frequencies corresponding to weaker radioactive sources and higher frequencies corresponding to higher activity radioactive sources to be simulated, perhaps for detection using a radiation detector.

Pulse shaping circuit 52 shapes the electrical pulses by controlling one or more characteristics of the electrical pulses (and corresponding characteristics of the light pulse emissions). For example, pulse shaping circuit 52 may control decay times, of the electrical pulses and corresponding light pulse emissions, in one embodiment. Light output intensity of the light pulses may be controlled by processing circuitry 44 using DAC 48 and frequency of the light pulses may be controlled by processing circuitry 44 using switch 50.

As discussed below, pulse shaping circuit 52 includes an RC circuit which controls the time constant of decay of the pulses. In one embodiment, the RC circuitry uses a digital potentiometer which is controlled by processing circuitry 44 to select different resistances of the potentiometer and corresponding different decays of the pulses of light emitted by light source 54. In other embodiments, the time constant of the decay of the pulses may be manually controlled or selected.

As discussed herein, the drive circuitry is configured to adjust the drive signal at a plurality of moments in time (e.g., for different serial electrical pulses) to cause the emission of light pulses from the light source having different characteristics at the different moments in time and which correspond to different light emissions. As mentioned above, example characteristics of electrical pulses of the drive signal which may be varied include amplitude, decay time and frequency which cause corresponding changes to the light pulses emitted by the light source 54. In one embodiment, the drive circuitry is configured to adjust the drive signal to adjust the intensities and decay times of the light pulses emitted from the light source at different moments in time.

The electrical pulses shaped by circuitry 52 of the drive circuitry are applied to light source 54. In one embodiment, light source 54 is implemented as a light emitting diode (LED) to replicate the light output of a scintillator. LEDs operate on low voltage DC, and the amplitude of light output is easily adjustable by changing the current through the LED. LEDs emit photons with a single dominant wavelength and are available in a wide range of wavelengths based on the semiconductor material type. The wavelength of light emitted from an LED can be matched to within 5-10 nm or less of light emitted by a scintillator to be simulated in some implementations.

In one embodiment, the light source 54 is chosen to match the wavelength of the scintillator being replicated as closely as possible (e.g., 5-10 nm), and have a luminous output high enough for the detector to register. Example LEDs which may be used include a Nichia NSPB500AS blue LED with wavelength λ=465 nm and forward voltage of 3.2V, a Roithner 420-01 blue LED with luminous intensity of 15 mW at 20 mA, wavelength λ=420 nm and forward voltage of 3.2V, and a Lighthouse LED 5MMFLATTOPLEDUV with Luminous intensity of 2000 mcd at 20 mA, wavelength λ=400 nm and forward voltage of 3.0V.

The LED output intensity can be controlled by the current driven through it and it is desirable to use a LED with a relatively linear relationship of radiant intensity versus LED forward current in some embodiments. The radiation pattern of the LED light output may also be considered when selecting an LED in some implementations. A wide viewing half-angle allows for better approximation of the relative radiant intensity due to the physical alignment of the LED and a corresponding photo sensor arranged to receive the light pulses. In general, LEDs with a wider viewing half-angle should make the physical setup, LED/photo sensor alignment, and calibration easier, as the change in radiant intensity per degree is more gradual. The Roithner 420-01 LED has a narrow viewing half-angle of±8° while the Lighthouse LED 5MMFLATTOPLEDUV has a relatively wide viewing half-angle of±55°.

Some implementations of calibration system 40 include a single light source 54, such as a single LED, configured to emit a single wavelength of light corresponding to a respective type of scintillator. In some embodiments, the light source 54 is interchangeable to generate light of different wavelengths to replicate different scintillators. In other embodiments, a plurality of light sources 54, such as a plurality of LEDs having different wavelengths, may emit light corresponding to different scintillators simultaneously, for example, for use with some radiation detector configurations which use more than one scintillator type for calibration.

In one example application, the light pulses generated and emitted by light source 54 are outputted from calibration system 40 and received by a radiation detector 60, which may include a photo sensor 56 and measuring device 58 such as a multi-channel analyzer (MCA). In some embodiments, a fiber optic cable may be used to couple the light source 54 and photo sensor 56. Photo sensor 56 outputs electrical signals corresponding to the received light pulses and measuring device 58 receives the electrical signals and creates a spectrum, for example as shown in FIG. 2.

In one embodiment, calibration system 40 replicates an energy spectrum of light pulses having a plurality of different intensities which are the output of a scintillator. For example, calibration system 40 may access and use a file of spectrum data to generate a synthetic energy spectrum of light pulses having different intensities and which corresponds to the energy spectrum of light emitted from the scintillator. In one embodiment, the file of spectrum data is stored within memory 46 of processing circuitry 44 and processing circuitry 44 utilizes the spectrum data to control the generation of light pulses having different characteristics defined by the spectrum data.

The spectrum data comprises a plurality of data values which define the different amplitudes of the electrical pulses and the number of pulses to be generated at each amplitude in one embodiment. The processing circuitry 44 uses the spectrum data to step the DAC 48 through its voltage range to adjust the amplitudes of the electrical pulses (and intensities of the corresponding light pulses), and to specify how many electrical and light pulses are generated at each voltage value to create the desired spectrum of light. In one embodiment, the spectrum data is stored in a file as an array and specifies the number of counts (i.e., pulses) for each channel (i.e., amplitudes/intensities) corresponding to one of the DAC 48 settings. In one embodiment, the index of the array represents the channel of the measuring device corresponding to different intensities of received light. The number of counts/pulses for each channel (corresponding to different settings for the DAC 48) are specified by the value stored at that array index in one embodiment.

An example of spectrum data which may be used is shown in Table A. In one operational embodiment, the processing circuitry 44 proceeds in order through the channels from 0 to 20 and controls the generation of different numbers of lights pulses corresponding to the count value for each of the channels.

TABLE A

| | | Corresponding Values | |
|---|---|---|---|
| Spectrum Data | | DAC | |
| Channel | Counts | Setting | Voltage |
| 0 | 0 | 0 | 0 |
| 1 | 0 | 205 | 0.0499712 |
| 2 | 0 | 410 | 0.0999424 |
| 3 | 5 | 614 | 0.1499136 |
| 4 | 20 | 819 | 0.1998848 |
| 5 | 40 | 1024 | 0.249856 |
| 6 | 80 | 1229 | 0.2998272 |
| 7 | 40 | 1434 | 0.3497984 |
| 8 | 20 | 1638 | 0.3997696 |
| 9 | 5 | 1843 | 0.4497408 |
| 10 | 5 | 2048 | 0.499712 |
| 11 | 10 | 2253 | 0.5496832 |
| 12 | 20 | 2458 | 0.5996544 |
| 13 | 10 | 2662 | 0.6496256 |
| 14 | 5 | 2867 | 0.6995968 |
| 15 | 0 | 3072 | 0.749568 |
| 16 | 0 | 3277 | 0.7995392 |
| 17 | 0 | 3482 | 0.8495104 |
| 18 | 0 | 3686 | 0.8994816 |
| 19 | 0 | 3891 | 0.9494528 |
| 20 | 0 | 4096 | 0.999424 |

Table A also shows the DAC settings and resultant peak voltages (the peak voltages being applied after voltage division to a switch 50 shown in FIG. 8A) corresponding to the spectrum data. Table A is merely an example for discussion purposes of synthetic spectrum generation and the spectrum data may specify the generation of numerous light pulses (approximately 1 million light pulses, or more or less) in typical implementations for creating a desired synthetic spectrum of light which corresponds to emissions of a scintillator. Furthermore, the spectrum data may be stored and accessed in any appropriate manner and may comprise different data values for controlling the emission of light from the light source in other arrangements. In addition, other arrangements may be used to generate a spectrum of synthetic light pulses from the calibration system in other embodiments.

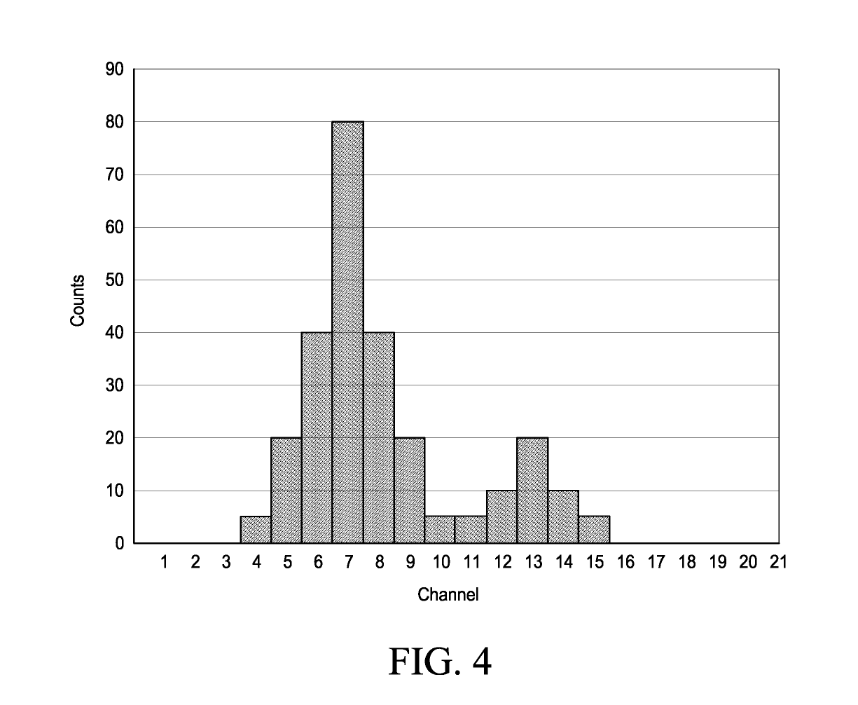

Referring to FIG. 4, a spectrum captured or recorded by the measuring device (such as a MCA) as a result of the reception of light pulses generated and output by system 40 using the spectrum data of Table A is shown according to one embodiment. Different spectrum data may be used to generate different synthetic spectrums which correspond to different sources for use in calibration of different radiation detectors in one embodiment. In FIG. 4, the x-axis represents different energy levels of the pulses (different amplitudes/intensities) and the y-axis is the number of counts/pulses at each amplitude/intensity.

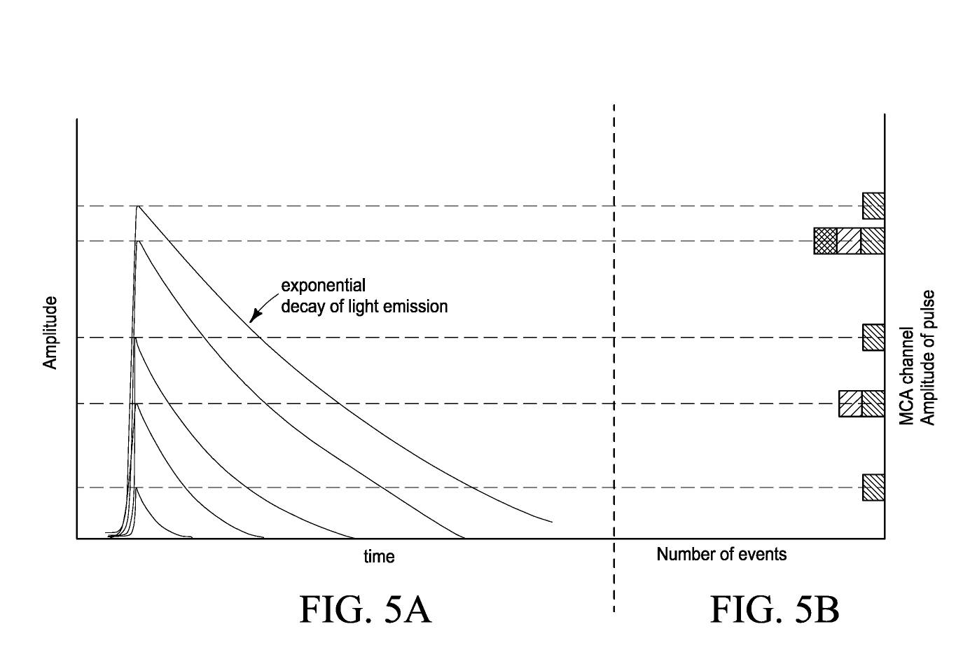

Referring to FIG. 5A, a graphical representation of light pulses having different amplitudes with associated decay are shown with respect to time, while FIG. 5B represents the spectrum generated by the measuring device as a result of receiving the light pulses including number of events for each channel of an MCA. A plurality of entries of the spectrum data may be used to generate a decaying pulse of a single amplitude, or an entire synthetic energy spectrum including a plurality of pulses having different amplitudes which correspond to a spectrum of light emitted by a scintillator.

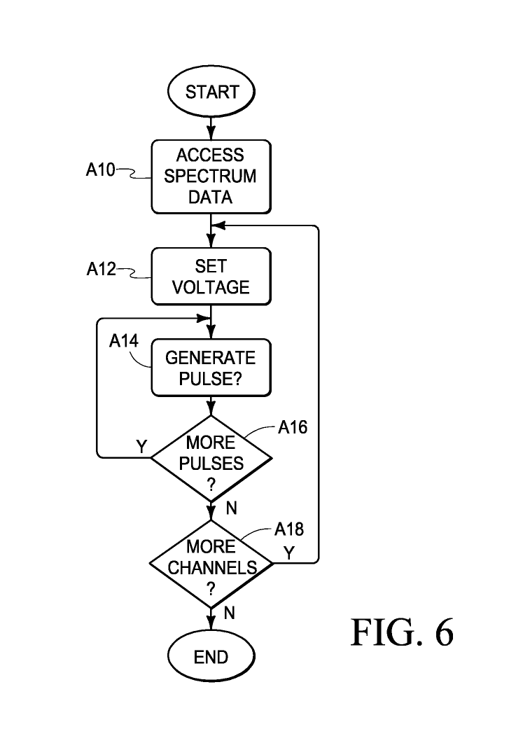

Referring to FIG. 6, a flowchart is shown of an example method of generating a synthetic energy spectrum corresponding to a spectrum of light emitted by a scintillator. The flowchart may be performed by the processing circuitry executing programming in one implementation. Other methods are possible including more, less and/or alternative acts.

At an act A10, spectrum data to be utilized to generate the synthetic energy spectrum is accessed. The spectrum data may be accessed from memory or other storage circuitry by the processing circuitry. A user may load one or more set of spectrum data into the calibration system for use in replicating synthetic energy spectrums of one or more scintillators. An example of the spectrum data is shown in Table A above.

As described below, the example method includes a plurality of different loops which are executed using the spectrum data to generate the synthetic energy spectrum. A first loop of the illustrated method is executed in a plurality of iterations to cause the emission of light having different intensities. A second loop of the illustrated method is executed in a plurality of iterations to cause the generation of different numbers of pulses of the light having the different intensities in accordance with the spectrum data.

At an act A12, one of a plurality of voltages of the drive signal is selected using the spectrum data. The light source emits light at a plurality of different intensities according to drive signals having different voltages. Referring to the example spectrum data of Table A, the method selects a different channel during each execution of act A12. For example, an initial voltage of the drive signal is selected during the first execution of act A12 (i.e., 0 V according to channel 0 of the spectrum data of Table A). Different voltages corresponding to the remaining channels of Table A may be selected during subsequent executions of act A12.

At an act A14, drive signals having a selected amplitude may be generated during different executions of act A14 in accordance with the spectrum data. The “counts” value of the spectrum data specifies the number of drive signals which are to be generated for the currently selected channel of the spectrum data. In the example of Table A, zero drive signals are generated for each of channels 0-2 while five drive signals having a voltage of 0.1499136 are generated during the execution of act A14 for channel 3 which cause the emission of five pulses of light from the light source. For channel 4, twenty drive signals having a voltage of 0.1998848 are generated during the execution of act A14 and so on until drive signals for each of the channels of the spectrum data (i.e., up to channel 20 in the example of Table A) are generated.

At an act A16, it is determined whether additional pulses should be generated following the execution of act A14 for the respective channel. For example, for channel 3, four additional drive signals need to be generated, and accordingly the process returns to act A14 four times to generate the additional drive signals having the respective voltage for channel 3.

Following the generation of the appropriate number of electrical pulses of the drive signal for the given channel, it is determined whether electrical pulses for additional channels still need to be generated at an act A18. If so, the process returns to act A12 to set the voltage of the drive signal(s) to be generated for the next channel and the appropriate number of drive signals are generated. If the result of act A18 is negative, the process terminates as the drive signals for each of the channels have been generated. The generated drive signals for each of the channels results in the emission of a synthetic energy spectrum of light including a plurality of pulses corresponding to a spectrum of light emitted by a scintillator.

Referring to FIG. 7, one embodiment of processing circuitry 44 which may be utilized to control the light emissions from the calibration system is shown. The processing circuity 44 is implemented as a PIC32MX120F032B-I/SS microcontroller available from Microchip Technology Inc. in the depicted embodiment. Other configurations of processing circuitry 44 may be utilized in other embodiments.

Port B of the microcontroller is shown in FIG. 7 and includes a plurality of output pins which are coupled with circuitry of FIGS. 8A-8B. Pins 14, 21 and 25 are coupled with the DAC 48 and pin 14 outputs a DATA signal, pin 21 outputs a DAC_SYNC signal and pin 25 outputs a clock signal to control the generation of drive signals by DAC 48. Pin 18 applies a SW_CTL signal to control the operation of switch 50 to generate the drive signals which include square wave pulses in one embodiment which are applied to pulse shaping circuit 52. Pins 14, 22 and 25 are coupled with variable resistor 51 and pin 14 outputs data, pin 22 outputs a RES_CS signal and pin 25 outputs a clock signal.

The microcontroller outputs digital values via the DATA pin to DAC 48 and resistor 51 to control generation of the electrical pulses having different amplitudes and decay constants in the illustrated embodiment. The DAC_SYNC pin selects the DAC 48 as the device that the microcontroller is communicating with. When this pin goes low, serial data is transferred to DAC 48 on the falling edges of CLK. The DATA pin outputs (for the case of the DAC 48) the serial data that is input to the DAC 48 from the microcontroller. This data tells the DAC 48 what voltage to output. The SW_CTL pin controls the switch position, which creates the square wave output from switch 51. When SW_CTL is low, the switch output is 0V. When SW_CTL is high, the switch output is the DAC voltage output divided by four by the voltage divider in one embodiment. If operating in manual mode, the switch output is calculated based on the adjustable value of resistor 53. When the RES_CS pin is low, it selects the digital resistor 51 as the device the microcontroller communicates with. When RES_CS returns to high, data in the serial input register is used to set the resistance of resistor 51. The DATA pin outputs (for the case of the resistor 51) the serial data that is input to the digital resistor 51 from the microcontroller. This data tells the resistor 51 what resistance to assume. The RUN_STOP pin is an input to the microcontroller and the voltage of RUN_STOP is controlled via a panel-mount switch the user toggles in one embodiment. When RUN_STOP goes high, the microcontroller program will start running the spectrum replication code. When RUN_STOP is low, the spectrum replication code is not running. The TRIG pin outputs a square wave with a rising edge right before the pulse rising edge. This signal can be used to coordinate measurement devices, so they can know when a pulse is about to happen.

Referring to FIGS. 8A-8B, one embodiment of drive circuitry configured to generate and apply drive signals to a respective light source is shown. The example depicted circuit permits control of current through a light source with high precision to accurately mimic the response of a scintillator to an external radiation source in one application. Other circuits may be used in other embodiments.

Amplitude of the current pulse through the light source 54 determines the light output by the light source 54. The current is induced by applying voltage across a 49.90 resistor in series with the light source 54. Pulse amplitude is adjusted by programming the DAC 48 to output 0-4V. In another embodiment, the output of the DAC 48 is held constant at 4 Volts and an optional variable resistor 49 (e.g., 1 kOhm) may be manually controlled to vary the amplitude of electrical signals applied to switch 50.

The resistors intermediate the DAC 48 and switch 50 provide voltage division of the signals outputted from the DAC 48. For example, the DAC 48 outputs a signal having a selected voltage within a range of 0-4V, however, the voltage division reduces the voltage of the signals to a corresponding range of 0-1 V before application of the signals to switch 50 for use to generate light pulses. Adjustable trim resistor 47 is optional and provides a tuning adjustment to allow the user to vary its resistance within a range of 0-1 kOhms to account for variances in the circuit components.

Switch 50 receives electrical energy having the desired voltage selected by the processing circuitry 44 and generates a plurality of square wave pulses which are applied as initial drive signals to pulse shaping circuit 52. Pulse shaping circuit 52 is used in the illustrated embodiment to shape and apply electrical pulses to light source 54 to cause the emission of light pulses which are used for calibration. The decay is produced by a CR network in the circuit. The amplitude of the light pulse is determined by the amplitude of current flowing through the light source 54. The expected current pulse (I) is

I=Iₒe^{-t}/τ

Where τ is the RC time constant of the pulse shaping circuit 52, and Iₒ is the peak current amplitude. The shape of the light pulse outputted by light source 54 matches the shape of the current pulse outputted by the pulse shaping circuit 52.

The time constant of decay of the pulses is determined by pulse shaping circuit 52 in the form of a CR circuit including a 1 nF capacitor, 49.9Ω series resistor, and a variable resistor (e.g., 1 kΩ 8-bit digital potentiometer) 51 in one embodiment. The decay can be changed by changing the value of the digital potentiometer operated in rheostat mode as a variable resistor, for example responsive to control by processing circuitry 44. In some embodiments, the variable resistor 51 is set to a fixed value and an optional variable resistor (e.g., 1 kOhm turn potentiometer) 53 may be used to allow a user to manually set an analog decay adjustment. Adjustable trim resistor 55 is optional and provides a tuning adjustment to allow the user to vary its resistance within a range of 0-1 kOhms to account for variances in the circuit components.

The theoretical decay time from Vₚₑₐₖ to Vₚₑₐₖ/e can be calculated by

$$τ = C * ( {R}_{s} + {R}_{pot} ) = C * ( {R}_{s} + \frac{P}{256} * {R}_{AB} + {R}_{W} ) = 1 nF * ( 49.9 Ω + \frac{P}{256} * 1 k Ω + 50 Ω ) = 1 \times {10}^{- 9} * ( 99.9 + \frac{1000}{256} * P ) sec$$

where Rₚₒₜ is the equivalent resistance of the variable resistor 51, Rₛ=49.9Ω is a series resistor, R_{AB}=1kΩ is the maximum resistance of the variable resistor 51, Rw=50Ω is the wiper resistance (from datasheet), and P is the potentiometer tap (0<=P<256).

Amplitude of the current pulse through the light source determines the light output by the light source. The current is induced by applying voltage across a 49.9Ω resistor in series with the light source which is implemented as an LED in this example. The pulse amplitude is adjusted by programming the 4096 channel DAC 48 to output 0-4V, which is reduced to 0-1V via the voltage divider. This gives a resolution of

$$\frac{1 V}{{2}^{12}} = .000244 V .$$

Peak pulse voltage is calculated by:

$${V}_{peak} = D * \frac{( \frac{1}{4} {V}_{DAC , max} )}{4096} = .000244 D$$

where V_{DAC,max}=4V and D is the DAC channel set by the processing circuitry 44. LED peak current amplitude is calculated as

$${I}_{LED , peak} = \frac{{V}_{peak}}{49.9 Ω} = 4.89 * {10}^{- 6} * D$$

Instantaneous current is given by

$${I}_{LED} = {I}_{LED , peak} * {e}^{\frac{- t}{τ}} = 4.89 * {10}^{- 6} * D * {e}^{\frac{- t}{1 \times {10}^{- 9} * ( 109.9 + 4.2 P + .00064 {P}^{2} )}}$$

As mentioned above, some arrangements permit a user to manually select one or more characteristics of the light pulses, such as amplitude, decay and/or frequency. The manual selection may be used in single-point energy calibration (i.e., light pulses of a single intensity) or multi-point energy calibration (i.e., light pulses of plural intensities) in some calibration operations. Alternatively, spectrum data may be accessed by the processing circuitry 44 to generate a synthetic energy spectrum corresponding to the light emitted by a scintillator including numerous light pulses of different amplitudes and different numbers of emissions of the light pulses having the different amplitudes as described above.

For embodiments which use an LED as light source 54, the amount of light output at a specific current is determined by the LED's luminous intensity. LED's can be procured in a wide range of intensities. LED maximum luminous intensity, relative luminous intensity plot, and relative radiant intensity plot can be procured from LED datasheets and used to calculate the light energy incident on a surface based on the current going through the LED and the orientation of the LED in relation to the surface.

Still referring to FIGS. 8A-8B, the illustrated circuit includes a BNC output 62 which may be used for viewing the shaped electrical pulse from circuit 52, for example on an oscilloscope. Another BNC output (not shown) may be coupled with an amplified trigger output (TRIG) of the microprocessor shown in FIG. 7 and used to determine when light pulses should be occurring and/or to synchronize the measuring device. The calibration system 40 may also include an indicator light (now shown) to indicate when the device is producing pulses in some embodiments.

In some embodiments, the light source 54 is housed separately from the other components of the calibration system 40 which allows the user to place the light source 54 in proximity to the radiation detector. In one embodiment, a 2-pin LEMO connector is used to supply the electrical pulses to the light source 54 although other connectors may be used in other embodiments.

As mentioned above, a plurality of different light sources 54 may be used in some implementations, for example, to simulate emissions from a plurality of scintillators. In one embodiment, the different light sources 54 may emit light of different respective wavelengths. In some arrangements, the calibration system may emit the light from the different light sources simultaneously.

In one example embodiment, a plurality of drive circuits shown in FIGS. 8A-8B may be provided for the different light sources and controlled by the microcontroller shown in FIG. 7. The drive circuits may be used to independently control characteristics of the emitted light, such as amplitude and decay time. Processing circuitry 44 includes a plurality of outputs for providing control of the light emissions of the different light sources in one embodiment. For example, pins 21, 23, 6 output three different DAC_SYNC signals and pins 22, 24, 11 output three different RES_CS signals to three respective drive circuits which are used to control the light emissions from three different light sources in one embodiment. In one implementation, the microprocessor controls simultaneous pulse emissions from the plural light sources 54. The use of plural light sources allows simulation of multiple scintillators by adjusting amplitude and decay time, difference between outputs resulting from plural light emissions to identify source, use of multiple light sources (e.g., LEDs) with different wavelengths and decay constants, and emission of light pulses from plural light sources at the same time to simulate a radiation event in illustrative examples.

As described above, some embodiments decouple the light generation from the signal generation and the user has the ability to readily customize their light source for coupling to a photo sensor (e.g., photomultiplier tube (PMT)) for example of the radiation detector being calibrated. In the simplest form, the light source is an LED that the user couples to a photo sensor in one embodiment. The device architecture implemented in some arrangements allows the user to easily and quickly change the light-output characteristics of the device by swapping light sources (e.g., swapping LEDs having different wavelengths of light emission). Some pulse generator embodiments allow for the user to control multiple light sources simultaneously and with correlation. Some embodiments of the disclosure are suitable for the calibration of radiation detectors and may also be used as synthetic scintillators given the realistic scintillation light output pulses and the ability to precisely control the light output of the light source(s) 54.

According to one operational embodiment and to reproduce the response of a scintillator to a radioactive source, the user uploads either a simulated spectrum or previously acquired spectrum (from a laboratory measurement for example) to the calibration system 40 via a USB connection or other suitable arrangement. The calibration system 40 may ramp the intensity of the light emission from the light source 54 to recreate an equivalent energy spectrum, or the calibration system 40 can be programmed to randomly sample the uploaded spectrum and generate corresponding light pulses to simulate a more realistic acquisition in some embodiments.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A calibration system comprising:
a light source configured to emit light; and
drive circuitry coupled with the light source, and wherein the drive circuitry is configured to apply a drive signal to the light source to cause the emission of the light from the light source which corresponds to a light emission from a scintillator resulting from exposure of the scintillator to a radioactive source.

2. The system of claim 1 wherein the drive circuitry is configured to adjust the drive signal at a plurality of moments in time to cause the emission of the light from the light source having different characteristics at the different moments in time and which correspond to different light emissions.

3. The system of claim 1 wherein the drive circuitry is configured to adjust the drive signal to adjust the intensities and decay times of the light emitted from the light source at different moments in time.

4. The system of claim 1 wherein the drive circuitry is configured to adjust the drive signal to cause the emission of light from the light source which corresponds to an energy spectrum of light emitted from a scintillator.

5. The system of claim 1 wherein the drive signal causes the emission of the light from the light source in a plurality of pulses, and wherein the drive circuitry is configured to access a plurality of data values which control the emission of the pulses having a plurality of different amplitudes and different numbers of the pulses having the different amplitudes.

6. The system of claim 1 wherein the drive circuitry is configured to generate the drive signal comprising a plurality of electrical pulses to cause the generation of a plurality of light pulses from the light source.

7. The system of claim 6 wherein the drive circuitry is configured to adjust an amplitude of the electrical pulses.

8. The system of claim 6 wherein the drive circuitry is configured to adjust decay times of the electrical pulses.

9. The system of claim 6 wherein the drive circuitry is configured to adjust a frequency of the electrical pulses to simulate different levels of radioactivity.

10. The system of claim 6 wherein processing circuitry of the drive circuitry is configured to output a plurality of different digital values to control generation of the electrical pulses having different amplitudes.

11. The system of claim 6 wherein processing circuitry of the drive circuitry is configured to output a plurality of different digital values to control generation of the electrical pulses having different decay times.

12. The system of claim 1 wherein the light source is configured to emit the light having a wavelength which corresponds to a wavelength of light emitted by a scintillator.

13. The system of claim 1 wherein the light source comprises a light emitting diode.

14. The system of claim 1 wherein the light source is a first light source which is configured to emit light having a first wavelength, and further comprising at least one additional light source configured to emit light having a second wavelength different than the first wavelength.

15. The system of claim 1 wherein the emitted light from the light source is useable to calibrate a radiation detector.

16. A calibration system comprising:
drive circuitry configured to output a drive signal comprising a plurality of electrical pulses;
a light source coupled with the drive circuitry and configured to generate a plurality of light pulses corresponding to the electrical pulses; and
wherein the drive circuitry is configured to access spectrum data corresponding to an energy spectrum of light emitted from a scintillator and to use the spectrum data to generate the electrical pulses having a plurality of different amplitudes to cause the generation of the light pulses by the light source having a plurality of different intensities.

17. The system of claim 16 wherein the drive circuitry is configured to use the spectrum data to generate the electrical pulses having different decay times to cause the generation of the light pulses by the light source having a plurality of different decay times.

18. The system of claim 16 wherein the drive circuitry is configured to use the spectrum data to generate different numbers of electrical pulses having the different amplitudes.

19. The system of claim 16 wherein the drive circuitry is configured to vary a frequency of the electrical pulses to simulate different levels of radioactivity.

20. The system of claim 16 wherein the drive circuitry is configured to use the spectrum data to cause the generation of the light pulses by the light source which correspond to the energy spectrum of light emitted from the scintillator.

21. The system of claim 16 wherein the light source is configured to output the light pulses having a wavelength which corresponds to a wavelength of light emitted by a scintillator as a result of received radiation.
